(19) United States
(12) Patent Application Publication
(10) Pub. No.: US 2009/0102148 A1
(43) Pub. Date: Apr. 23, 2009

(54) GROCERY CART COVER

(76) Inventor: SHARON BRUNER, Monroe, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 12/251,749

(22) Filed: Oct. 15, 2008

Related U.S. Application Data
(60) Provisional application No. 60/981,163, filed on Oct. 19, 2007.

(51) Int. Cl. B62D 39/00

(52) U.S. Cl. 280/33.992

(57) ABSTRACT

The current invention relates to a cover, top, or lid that can be used on grocery carts or other containers to prevent rain, dust, dirt, wind, sun, among others, from corrupting the contents of a grocery cart or other container. The current invention is lightweight, foldable, sturdy, and waterproof or water resistant. It can easily be stored or transported in a vehicle, pocket, or handbag.

### CROSS-REFERENCES TO RELATED APPLICATIONS

This Application claims priority from provisional patent application 60/981,163 filed on 19 Oct. 2007 and incorporates that application in its entirety herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

This Application claims priority from provisional patent application 60/981,163 filed on 19 Oct. 2007 and incorporates that application in its entirety herein by reference.

### GENERAL DESCRIPTION

The current invention relates to a cover, top, or lid that can be used on grocery carts, or other containers, to prevent rain, dust, dirt, wind, sun, among others, from corrupting the contents of a grocery cart or other container.

### BACKGROUND OF INVENTION

A main object of this invention is to provide a novel and improved device of simple construction to protect the contents of a grocery cart or other container from being corrupted by rain, dirt, dust, sun, snow, among others, during transport.

Prior art is limited in this area. For example, covers for an industrial laundry cart, which have an arm extending upwards, is commonly known. These covers are however, bulky and cannot be used on more common containers such as grocery carts. The current invention is portable and light.

Walters U.S. Pat. No. 4,960,302 discloses a trapezoidal cover for a grocery cart. The trapezoidal cover disclosed in Walters is difficult to use because the user is required to align the cover with the grocery cart. This is a difficult chore when the user is fighting wind, snow, rain, among others. The current invention does not require the user to align the cover to particular sides of the grocery cart or other container.

Walton U.S. Pat. No. 5,271,634 discloses a retractable grocery cart cover which is attached to the grocery cart. The draw back of this system is that the mechanism to retract the cart will deteriorate with time. The current invention is simple in construction and design and therefore, can be used for a long period of time, even with repeated use.

Additionally, the Walton disclosure is bulky and not easily storable in a pocket or handbag. The current invention folds into a neat packet held secure by a closure strap and can be stored in small spaces such as a vehicle, pocket, or hand bag. Also, the current invention is light enough that a child can carry it.

Finally, when prior art is used on a grocery cart, a child cannot sit in the child seat. The present invention allows a child to sit in the child seat while the invention is in use.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a side view of a cover;

FIG. 2 is a bottom view of a cover;

FIG. 3 is a prospective view of the preferred embodiment on a grocery cart;

FIG. 4 is a top view of the cover when folded and held in place with the closure strap.

### DETAILED DESCRIPTION OF THE INVENTION

The current invention relates to a cover that can be used on grocery carts or other containers to prevent rain, dust, dirt, wind, sun, among others, from corrupting the contents of a grocery cart or other container.

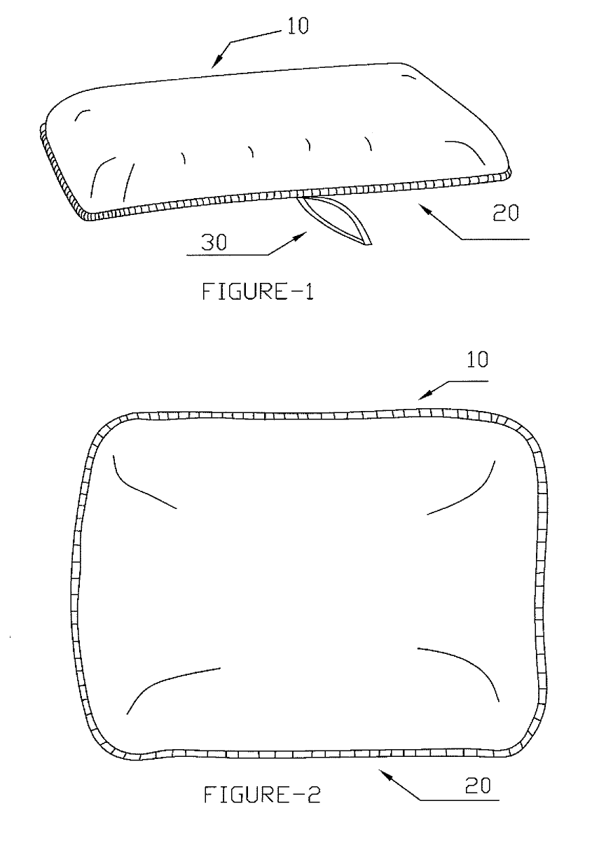

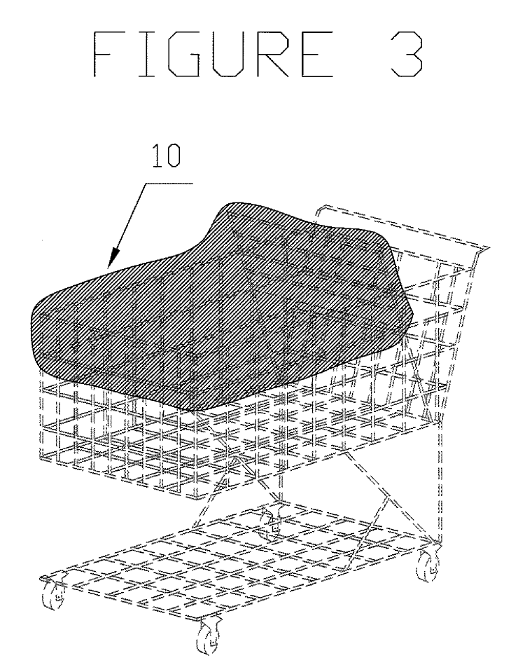

FIG. 1 is a side view of a cover which can be used on a grocery cart or other container. The cover 10 comprises a portion of material which is lightweight, foldable, sturdy and water resistant or waterproof. The periphery 20 of the material is skirted with elastic or other material that will help secure it upon the container. FIG. 2 is a bottom view of the cover showing the periphery 20 of the cover 10.

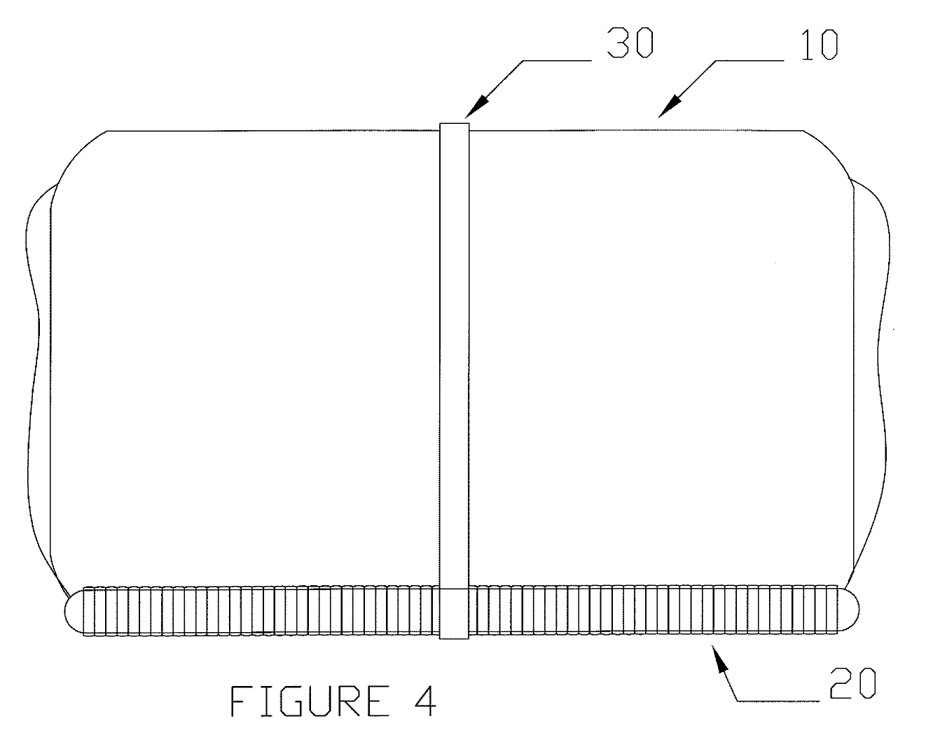

The cover is put on top of the object and held snug at the periphery 20. FIG. 3 shows the cover 10 as it would sit on a grocery cart.

FIG. 1 also shows a closure strap 30 that is attached to the cover 10. The cover 10 can be folded and held in place with the closure strap for ease of storage and transport. FIG. 4 shows how the cover 10 may look when folded and held in place by the closure strap 30.

In view of the above it will be seen that various aspects and features of the invention are achieved and other results and advantages attained. While preferred embodiments of the invention have been shown and described, it will be obvious to those skilled in the art that changes and modification may be made therein without departing from the invention in its broader aspects.

The invention claimed is:

1. An article of manufacture comprising a means to cover a shopping cart or other container.

2. The means to cover a shopping cart or other container of claim 1 is made of lightweight, foldable, sturdy, and waterproof or water resistant material.

3. The means to cover a shopping cart or other container of claim 2 has a periphery skirted with elastic.

5. The means to cover a shopping cart or other container of claim 2 has a periphery skirted with material allowing the means to cover a shopping cart or other container to stay in place once place on the shopping cart or other container.

6. The means to cover a grocery cart or other container of claim 2 further comprises a means to hold the cover in place when it is folded.
